(19) United States
(12) Patent Application Publication
(10) Pub. No.: US 2024/0310812 A1
(43) Pub. Date: Sep. 19, 2024

(54) METHOD FOR OPERATING A MACHINE TOOL AND/OR PRODUCTION MACHINE

(71) Applicant: Siemens Aktiengesellschaft, 80333 München (DE)

(72) Inventors: THOMAS PITZ, Rutesheim (DE); RALF SPIELMANN, Stuttgart (DE)

(73) Assignee: Siemens Aktiengesellschaft, 80333 München (DE)

(21) Appl. No.: 18/576,952

(22) PCT Filed: May 4, 2022
(86) PCT No.: PCT/EP2022/061989

§ 371 Date: Jan. 5, 2024

(30) Foreign Application Priority Data
Jul. 30, 2021 (EP) 21188805.2

(51) Int. Cl. G05B 19/4067; B23Q 11/00

(52) U.S. Cl. CPC G05B 19/4067; B23Q 11/0085

(57) ABSTRACT

In a method for operating a machine tool and/or production machine which includes a spindle and a tool for processing a workpiece, the tool is moved, when the spindle rotates and a feed rate of the tool is below a defined feed rate, to a retracted position such that the tool no longer touches the workpiece.

The invention relates to a method for operating a machine tool and/or production machine.

For example, the machining of lightweight materials is of interest in the prototype production of fuel cells. Some lightweight materials used for components, such as magnesium or magnesium alloys, are highly flammable.

This is particularly problematic if a rotating milling cutter remains on the component or workpiece. The milling cutter then rubs against the workpiece, the friction generates a lot of heat and it can start to burn.

There is also a risk of fire when processing wood due to the heat generated by friction.

The risk of fire is particularly high when processing workpieces comprising magnesium. Fine chips produced during such processing are highly flammable and can be ignited by small sparks or localized pockets of heat.

The object of the invention is to prevent fires in the processing area of a machine tool and to improve the processing of a workpiece.

The object is achieved by claim 1, i.e. a method for operating a machine tool and/or production machine, having a spindle and a tool for processing a workpiece, wherein the tool, when the spindle rotates and the feed rate of the tool is below a defined feed rate, is moved to a retracted position such that the tool no longer touches the workpiece.

The retracted position is a position in which the tool no longer touches the workpiece.

One embodiment is advantageous, in which the tool is moved to a retracted position, when the spindle rotates and the feed rate of the tool is below a defined feed rate, in such a way that a tool tip facing the workpiece is at a distance from the workpiece.

The tool is advantageously arranged on the spindle, in particular the tool is attached to the spindle.

Advantageously, the tool tip facing the workpiece is at a distance from a surface of the workpiece.

In this case, the tool tip is a front end of the tool, i.e. an end of the tool that points in the direction of the workpiece.

The tool tip is consequently not necessarily pointed; for example, the tool tip can also have a cutting edge.

In the case of machine tools and/or production machines, the feed rate indicates the speed of the tool in the feed direction and is preferably specified in mm/min.

A feed movement of the tool is used to process the workpiece.

The feed is advantageously achieved by feeding at least one axis.

The feed can also be achieved by the feed of multiple axes.

For example, the feed rate can be achieved by a feed of one or more axes of the machine tool and/or production machine.

The feed rate can also be achieved, for example, by a feed of one or more axes of the machine tool and/or production machine as well as by a feed of one or more axes of a robot, which advantageously operates in the working area of the machine tool and/or production machine.

If the feed rate is below the defined feed rate, the tool is moved to the retracted position.

The feed rate is below the defined feed rate, for example, if a desired feed or a desired feed rate cannot be provided by the motor of the machine tool and/or production machine during run-in, i.e. when a processing program for manufacturing a component or machining a workpiece is run for the first time.

It is possible, for example, that a machine operator (or even a controller) is not aware that the desired feed rate cannot be achieved by the motor.

The method according to the invention consequently has a protective function.

Another example is milling a square in a workpiece comprising wood. In order to mill the corners, for example, the feed rate must be slowed down so that a feed rate of zero is achieved. However, the spindle continues to rotate.

During braking, in this context, the feed rate is below the defined feed rate and the tool is moved to a retracted position in accordance with the method according to the invention.

The feed rate can also be at least essentially zero from one moment to the next, i.e. without braking.

Even if the feed rate is zero, it is below the defined feed rate.

An embodiment in which the tool is moved in a direction away from the workpiece is advantageous.

An embodiment in which the tool is moved in a Z+ direction is advantageous.

The Z+ direction advantageously describes a movement into free space. In this context, a Z− direction advantageously describes a movement that leads to material removal.

This is advantageous since there is no risk of unintentional material removal.

An embodiment in which the tool is moved in a tool orientation direction is advantageous.

This means advantageously: The retraction takes place in an inclined position of the tool in relation to the workpiece.

One embodiment is advantageous, in which a distance between the tool tip facing the workpiece and the workpiece after movement to the retracted position is at least 0.001 mm and at most 1000 mm, in particular at least 1 mm and at most 10 mm.

This is advantageous because the distance is large enough to prevent fires, for example. At the same time, the distance is not unnecessarily large and therefore does not lead to unnecessary travel distances.

An embodiment in which the defined feed rate is at most 1000 mm/min and at least 50 mm/min, preferably at most 500 mm/min and at least 100 mm/min, is advantageous.

This is advantageously dependent on the material to be processed.

Preferably, the feed rate can be preset via parameters.

If, for example, a workpiece comprising wood is being machined, it is advantageous to rotate the spindle at 30,000 rpm, for example. If the feed rate is below 500 mm/min, for example, the described retraction of the tool is advantageous in order to avoid a fire.

If, for example, a workpiece comprising metal and/or magnesium is being machined, a spindle rotation speed of 5,000 rpm, for example, is advantageous. If the feed rate is below 100 mm/min, for example, the described retraction of the tool is advantageous in order to avoid a fire.

The feed rate can also be 0, in which case there is no feed. Even then, the retraction of the tool is advantageous.

An embodiment in which the workpiece comprises at least one highly flammable or easily flammable or flammable substance, in particular a solid substance, is advantageous.

This is advantageously a substance that ignites easily when exposed to heat.

Heat or warmth is usually the result of a rotating spindle which, for example, touches the workpiece during its rotation.

The invention eliminates the risk of fire, since the ignited substance can continue to burn or smolder even after the spindle has been removed or the machine has moved on.

The invention is advantageous for workpieces comprising wood and/or magnesium, as already explained.

An advantageous embodiment is one in which the workpiece comprises at least one substance that is deformable by heat input.

The heat input can be caused by friction.

The invention is particularly suitable for workpieces comprising plastic, since this begins to flow or begins to deform in an undesired manner when heat is applied. Even then, the retraction of the tool is advantageous.

The method is also suitable for other materials.

For example, surfaces of workpieces and materials in general that have been treated with solvent or solvents are also highly flammable.

Furthermore, when exposed to heat, resin components can develop vapors that are explosive in combination with air.

The invention is also suitable for these examples.

The invention offers the advantage that production steps do not have to be adapted separately to a workpiece material. Since the tool is retracted, it is not necessary to pay attention to whether a material is used that starts to burn easily.

The following advantage is given using the example of a workpiece comprising magnesium: It is no longer necessary to prevent a fire by moving the tool slowly over the workpiece and adding plenty of coolant. Furthermore, it is no longer necessary to prevent highly flammable, fine chips by having a CAD/CAM system or a machine operator adjust parameters such as infeed depth, chip width, feed rate, spindle speed and/or feed per tooth to the material of the workpiece.

If a defined feed rate of the tool is exceeded again, for example if a feed rate of the tool is instructed again by a command, the tool is advantageously moved to the previous position, which allows processing. The previous position is the position that the tool had before it was moved to the retracted position.

However, it is also possible for the tool to be moved to a different position.

This method is advantageous since it reduces the amount of processing required. It also saves time and costs.

The object is also achieved by a machine tool and/or production machine for carrying out the method described, comprising a spindle and a tool for processing a workpiece.

Furthermore, the object is achieved by a system comprising a controller, in particular a numerical controller, and a machine tool and/or production machine.

The controller performs the following tasks, for example: control of production steps, monitoring of production sequences, storage of machine and/or tool data, storage of production programs and/or graphic simulation of production sequences.

The object is also achieved by a computer program product comprising commands which, when the program is executed by the controller, in particular a numerical controller, cause it to perform the described method.

The computer program product is advantageously stored in the controller.

In the following, the invention is described and explained in more detail with reference to the embodiments shown in the figures. In the drawings:

FIG. 1 shows a method sequence,

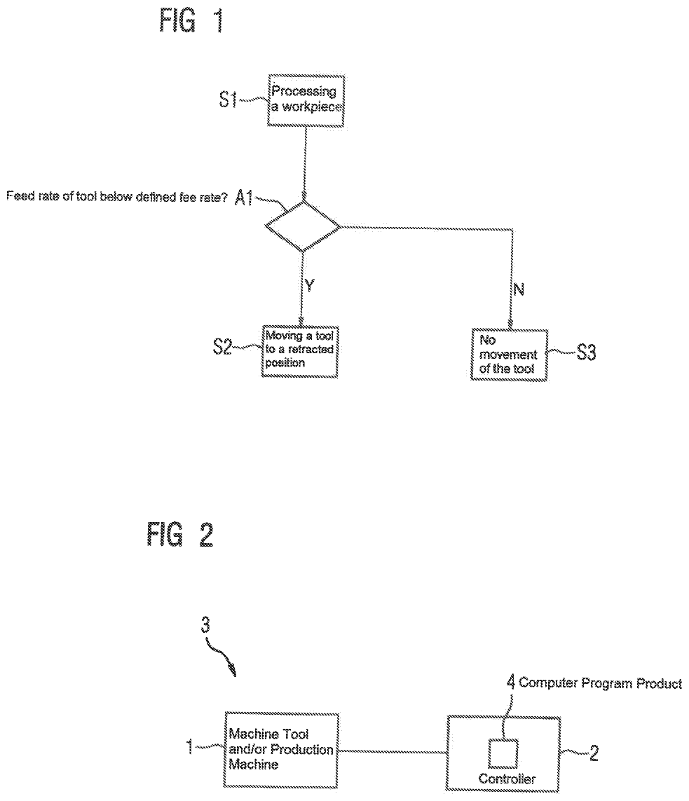

FIG. 2 shows a system,

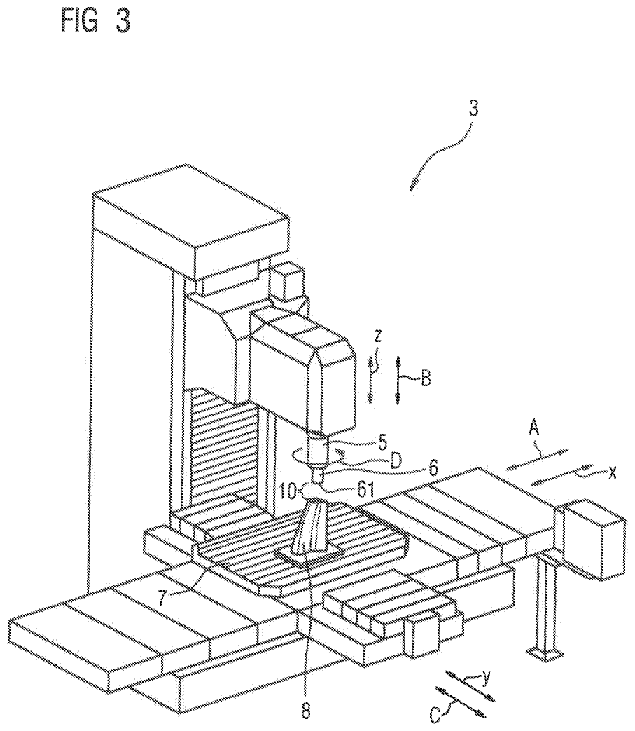

FIG. 3 shows a machine tool and/or a production machine,

FIG. 4 shows a processing position,

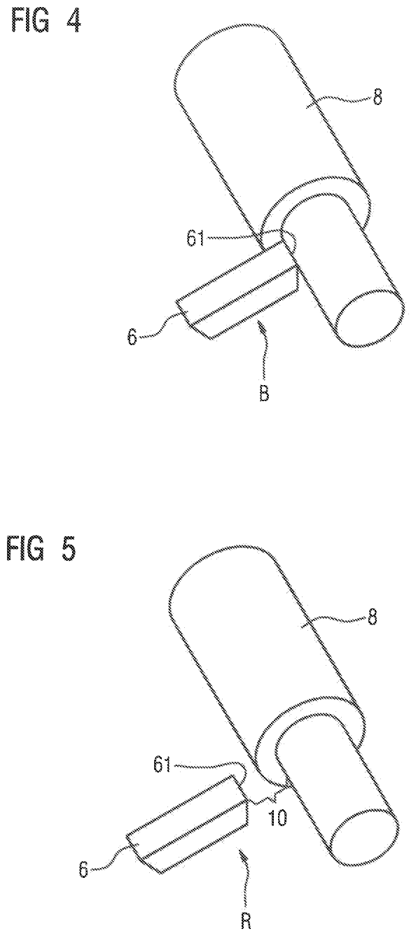

FIG. 5 shows a retracted position.

FIG. 1 shows the method sequence of the method for operating a machine tool and/or production machine 1 (see FIG. 3).

In a method step S1, a workpiece 8 is processed (see FIG. 3).

If a spindle 5 (see FIG. 3) rotates and the feed rate of a tool 6 (see FIG. 3) is below a defined feed rate, shown by A1, the path Y is followed in the method and the tool 6 is moved to a retracted position in a method step S2.

The retracted position is such that a tool tip 61 facing the workpiece 8 (see FIG. 3) is at a distance from the workpiece 8.

If the conditions according to query A1 are not met, the path N is followed and there is no movement to a retracted position R in a method step S3 (see FIG. 6).

FIG. 2 shows a system 3, having a controller 2, in particular a numerical controller, and the machine tool and/or production machine.

The figure shows that the controller 2 has a computer program product 4.

The computer program product 4 comprises instructions which, when a program is executed by the controller 2, cause the controller to perform the method shown in FIG. 1.

Advantageously, a plurality of commands are present in one program.

FIG. 3 shows the machine tool and/or a production machine 1.

The machine tool and/or production machine 1 comprises in the figure a spindle 5 and a table or work table 7.

The spindle 5 is connected to a tool 6. A rotation of the spindle 5 has an advantageous effect on the tool 6 in such a way that the tool 6 also rotates. A direction of rotation of the spindle 5 is indicated by D.

The workpiece 8 can be machined using the machine tool and/or the production machine 1.

Three axes X, Y and Z are available for this purpose, as well as travel paths A, B and C along the axes.

If the spindle 5 is rotating and the feed rate of the tool 6 is below the defined feed rate, the tool 6 is moved to a retracted position. This has already been explained above.

The spindle 5 advantageously continues to rotate and does not stop.

The tool 6 is moved in such a way that a tool tip 61 facing the workpiece 8 is at a distance from the workpiece 8.

This distance between tool tip 61 and workpiece 8 is indicated by the reference character 10.

The invention is advantageous, for example, if the workpiece 8 comprises a highly flammable or easily flammable or flammable substance, in particular a solid substance.

The method can improve the processing of such workpieces 8. For example, it can make the loading process safer.

When moving in workpieces or components that comprise highly flammable solids, the feed rate (also known as the path speed) can be greatly reduced or even stopped at critical points during processing using a so-called override function.

This can generate a great deal of friction, heat and even heat locally on the workpiece 8, which can lead to the ignition of chips. If the tool 8 is moved to the retracted position, this danger can be averted and the chips can be prevented from igniting.

The method is also advantageous, since wear of the tool 6 is prevented or delayed. Continuous friction between tool 6 and workpiece 8 causes the tool 6 to wear more quickly.

Increased wear occurs in particular when the workpiece 8 is processing materials such as so-called sandwich materials with carbon fiber, for example structural components in automotive engineering or materials for an aircraft outer skin

Wear can be minimized, since no friction occurs between workpiece 8 and tool 6 when moving to the retracted position at a low feed rate or at a feed rate equal to zero.

The method is also advantageous if special surface requirements are placed on the processed workpiece.

In the case of many materials, for example during milling, so-called cutter marks in the form of rings appear on a milled surface. Shiny rings can also be caused by turning if, for example, a turning chisel remains in one place on the surface of the workpiece 8 for too long without path movement or if the feed rate is zero or very low.

This can also be referred to as free cutting. Free cutting is greatly minimized by the method according to the invention.

FIG. 4 shows the tool 6 in a processing position B. The figure shows that material is removed in this way.

FIG. 5 shows the tool in the retracted position R. The distance 10 between the tool tip 61 and the workpiece 8 is present.

What is claimed is:

1.-11. (canceled)

12. A method for operating a machine tool and/or production machine which includes a spindle and a tool for processing a workpiece, the method comprising moving the tool, when the spindle rotates and a feed rate of the tool is below a defined feed rate, to a retracted position such that the tool no longer touches the workpiece.

13. The method of claim 12, wherein the tool is moved to the retracted position in such a manner that a tool tip facing the workpiece is at a distance from the workpiece.

14. The method of claim 12, wherein the tool is moved in a direction away from the workpiece, in particular in the Z+ direction.

15. The method of claim 12, wherein the tool is moved in a tool orientation direction.

16. The method of claim 13, wherein the distance between the tool tip and the workpiece after movement of the tool to the retracted position is at least 0.001 mm and at most 1000 mm, in particular at least 1 mm and at most 10 mm.

17. The method of claim 12, wherein the defined feed rate is at most 1000 mm/min and at least 50 mm/min, preferably at most 500 mm/min and at least 100 mm/min.

18. The method of claim 12, wherein the workpiece comprises a highly flammable or easily flammable or flammable substance, in particular a solid substance.

19. The method of claim 12, wherein the workpiece comprises a substance deformable by heat input.

20. A controller, in particular numerical controller, for a machine tool and/or production machine which includes a spindle and a tool for processing a workpiece, the controller comprising a computer program product embodied on a non-transitory computer readable medium comprising commands which, when executed by the controller, cause the controller to move the tool, when the spindle rotates and a feed rate of the tool is below a defined feed rate, to a retracted position such that the tool no longer touches the workpiece.

21. The controller of claim 20, wherein the controller is designed to move the tool to the retracted position in such a manner that a tool tip facing the workpiece is at a distance from the workpiece.

22. The controller of claim 20, wherein the controller is designed to move the tool in a direction away from the workpiece, in particular in the Z+ direction.

23. The controller of claim 20, wherein the controller is designed to move the tool in a tool orientation direction.

24. The controller of claim 21, wherein the distance between the tool tip and the workpiece after movement of the tool to the retracted position is at least 0.001 mm and at most 1000 mm, in particular at least 1 mm and at most 10 mm.

25. The controller of claim 20, wherein the defined feed rate is at most 1000 mm/min and at least 50 mm/min, preferably at most 500 mm/min and at least 100 mm/min.

26. The controller of claim 20, wherein the workpiece comprises a highly flammable or easily flammable or flammable substance, in particular a solid substance.

27. The controller of claim 20, wherein the workpiece comprises a substance deformable by heat input.

28. A system, comprising:
a machine tool and/or production machine including a spindle and a tool for processing a workpiece; and
a controller comprising a computer program product embodied on a non-transitory computer readable medium comprising commands which, when executed by the controller, cause the controller to move the tool, when the spindle rotates and a feed rate of the tool is below a defined feed rate, to a retracted position such that the tool no longer touches the workpiece.

29. A computer program product, embodied on a non-transitory computer readable medium comprising commands which, when executed by a controller, in particular a numerical controller, cause the controller to perform a method as set forth in claim 12.
